(19) United States
(12) Patent Application Publication
(10) Pub. No.: US 2025/0285291 A1
(43) Pub. Date: Sep. 11, 2025

(54) VIDEO SURVEILLANCE PROCESSING BASED ON DISTORTION IDENTIFIED IN VIDEO STREAMS

(71) Applicant: DRAGONFRUIT AI, INC., Menlo Park, CA (US)

(72) Inventors: Amit Kumar, Menlo Park, CA (US); Nathan Juraj Michlo, Gauteng (ZA)

(21) Appl. No.: 18/599,466

(22) Filed: Mar. 8, 2024

(51) Int. Cl. G06T 7/20; G06V 10/22; G06V 10/98; G06V 20/40; G06V 20/52

(52) U.S. Cl. CPC G06T 7/20; G06V 10/235; G06V 10/993; G06V 20/40; G06V 20/52

(57) ABSTRACT

Systems, methods, and software to process video surveillance data based on distortion identified in video streams. In one example, a computing device identifies a video stream from a video source and a map of a physical area monitored by the video source. The computing device further obtains user input identifying objects in the video stream and the map, wherein the user input for each of object of the objects correlates a tag of said object in the video stream to a tag of a representation of said object in the map. From the user input, the computing device calculates distortion in the video stream and monitors movement trends associated with additional objects based on the determined distortion, the user input, and the movement of the additional objects in the video stream.

### BACKGROUND

Video surveillance involves the use of cameras to monitor and record activities in a specific area. These cameras capture live footage, which can be viewed in real-time or stored for later analysis. Video surveillance is commonly employed for security purposes, such as monitoring public spaces, businesses, and homes to deter and detect criminal activities. Advances in technology have led to the integration of features like facial recognition and remote access to enhance the effectiveness of video surveillance systems.

The cameras used in association with the video cameras provide varying image qualities and lens designs to better capture the area of interest. For example, an organization will employ a fisheye lens or some other lens to capture a broader or wider view than a traditional camera lens. A fisheye lens provides a unique optical design that distorts straight lines near the edges of the frame, creating a characteristic spherical or barrel distortion effect. Fisheye lenses are commonly used in photography and videography to capture panoramic views or immersive shots, especially in confined spaces where a wider perspective is valuable. However, while different lenses and cameras provide a wider range of view over a particular area, difficulties arise in processing the video streams provided from the cameras due to different types of distortion caused by different lenses.

### OVERVIEW

Provided herein are systems, methods, and software to enhance video surveillance based on distortion identified in video streams. In one implementation, a method of providing surveillance for an area of interest includes identifying a video stream from a video source and identifying a map, wherein at least a portion of a physical area represented by the map is monitored by the video source. The method further includes obtaining user input identifying objects in the video stream and the map, wherein the user input for each of object of the objects correlates a tag of said object in the video stream to a tag of a representation of said object in the map. The method also includes determining distortion in the video stream based on the user input, monitoring the movement of one or more additional objects in the video stream, identifying one or more movement trends for the one or more additional objects in the physical area based on the movement, the user input, and the distortion.

In at least one implementation, the method further includes obtaining second user input for a new object in the map, wherein the second user input identifies a representation of the new object in the map. From the second user input, the method further provides generating a location suggestion for a tag of the new object in the video stream based on the distortion, the user input, and the second user input.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates a computing environment to process video surveillance data based on distortion identified in the video streams according to an implementation.

FIG. 2 illustrates a distortion correction operation to process video surveillance data based on distortion identified in the video streams according to an implementation.

FIG. 3 illustrates a user interface to obtain user input regarding an area of interest according to an implementation.

FIG. 4 illustrates a user interface demonstrating calculated distortion from user input according to an implementation.

FIG. 5 illustrates an operation to provide suggestions regarding object location based on distortion calculated for a video stream according to an implementation.

FIG. 6A illustrates a user interface to provide suggestions regarding object location based on distortion calculated for a video stream according to an implementation.

FIG. 6B illustrates a user interface to provide suggestions regarding object location based on distortion calculated for a video stream according to an implementation.

FIG. 7 illustrates a user interface indicating an overhead map according to an implementation.

FIG. 8 illustrates a user interface demonstrating a trend identified for a physical area from video streams according to an implementation.

FIG. 9 illustrates a computing system to process video surveillance data based on distortion identified in the video streams according to an implementation.

### DETAILED DESCRIPTION

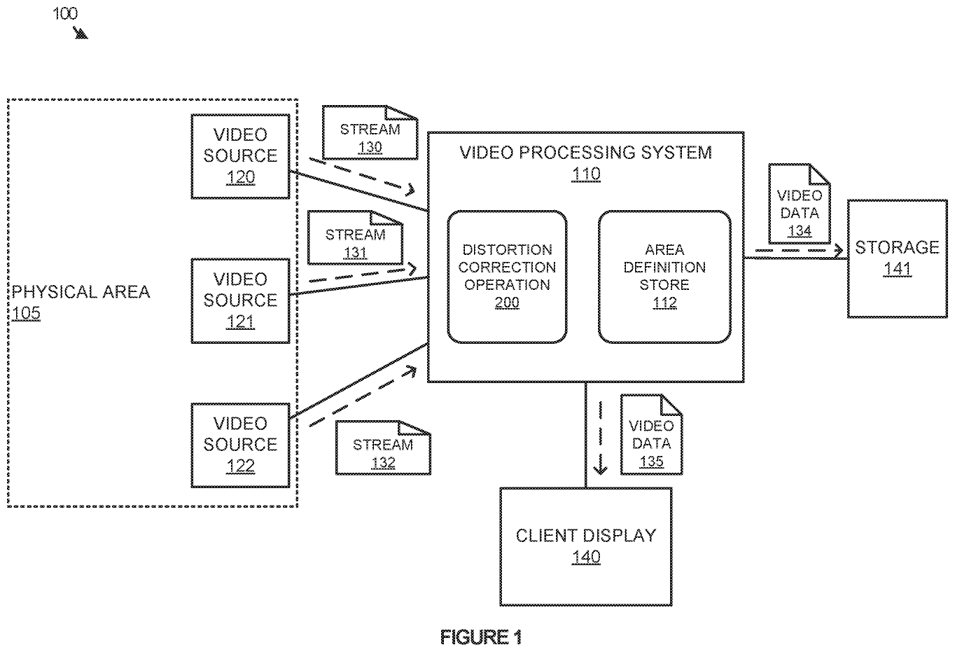

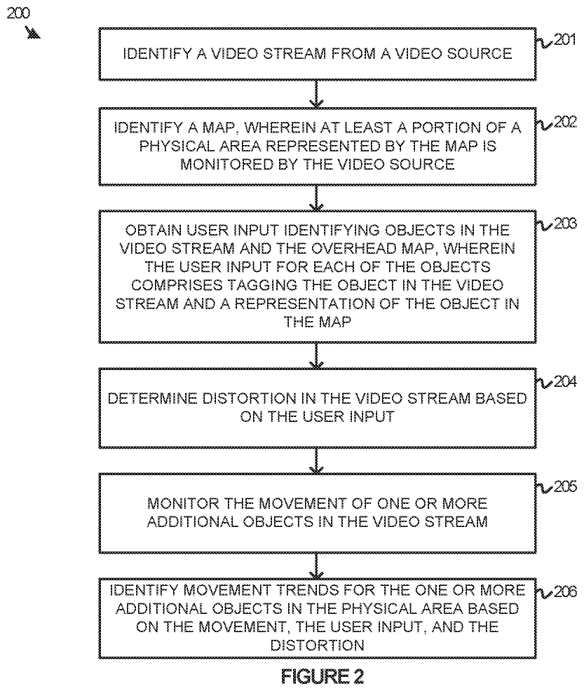

FIG. 1 illustrates a computing environment 100 to process video surveillance data based on distortion identified in the video streams according to an implementation. Computing environment 100 includes video processing system 110, video sources 120-122, video streams 130-132, client display 140, storage 141, and video data 134-135. Video processing system 110 further includes area definition store 112 and distortion correction operation 200 that is further described below with respect to FIG. 2.

In computing environment 100, video sources 120-122 provide video streams 130-132 to video processing system 110. Video sources 120-122 are representative of video surveillance cameras for physical area 105. A surveillance camera is a device equipped with a lens and sensors to capture and record visual information in a specific area, typically for security and monitoring purposes. It is commonly used in various settings, such as public spaces, businesses, and homes, to enhance safety and deter potential threats. The lenses on each video source of video sources 120-122 is associated with a different degree of distortion. Lens distortion (herein referred to as distortion) refers to the optical imperfections that can cause images to appear distorted or skewed. This phenomenon often occurs due to the curvature of the camera lens, resulting in straight lines appearing curved, especially towards the edges of the image. Distortion can be classified into two main types: barrel distortion, where straight lines near the edges of the frame curve outward, and pincushion distortion, where lines curve inward. In some examples, the distortion of a video source is known or is provided by the manufacturer, however, in other examples, the distortion of the camera is unknown, which can cause difficulties in accurately monitoring the movement of objects within physical area 105.

Here, to support accurate monitoring of object movement in the video streams, processing system 110 is provided. Video processing system 110 represents one or more computers capable of processing video streams 130-132 and providing video data 134 to storage 141 or video data 135 to client display 140. Video processing system 110 includes In at least one example, video processing system 110 can include a central processing unit (CPU), memory (RAM), storage (such as a hard drive or SSD), input devices (like a keyboard and mouse), output devices (such as a monitor), and a motherboard that connects and manages these components. Additionally, it requires an operating system to coordinate hardware and software interactions.

In one example, video processing system 110 supports distortion correction operation 200 using area definition store 112 provided by a user of video processing system 110. A user of video processing system 110 provides a map (as part of area definition store 112), wherein at least a portion of physical area 105 represented by the map is monitored by a video source of video sources 120-122. For example, in a store a video source 120 can capture video associated with a subset of aisles in the store. In addition to identifying the store, video processing system 110 further obtains user input that identifies objects in an associated video stream and the map, where the user input for each of the objects correlates a tag of the object in the video stream to a tag of a representation of the object in the map. For example, returning to the store example, the user will identify the corner or edge of a particular aisle (e.g., endcap) in the video stream and identify a representation of the same corner or edge in the map. In some implementations, the association in the map and video stream is referred to as a landmark. The user repeats the operation for multiple stationary objects in the video stream in relation to their corresponding location in the map, which permits video processing system 110 to identify the location and orientation of the camera relative to the physical area.

After the objects are identified in the map and the video stream, video processing system 110 further determines distortion in the video stream from the user input. For example, using video source 120, video processing system 110 can determine that the video source 120 provides video stream 130 with barrel distortion and the severity of barrel distortion based on the input from the user. Some video sources will include more severe distortion than other video sources or provide different variants of distortion. In some examples, the calculated distortion is further based on camera information provided by the manufacturer that indicates the likely distortion associated with the video source.

After the distortion is calculated for the video source, video processing system 110 monitors the movement of one or more additional objects in the video stream and identifies movement trends for the one or more additional objects in the physical area based on the movement, the user input, and the distortion. The additional objects can comprise people, robots, vehicles, or some other movable objects. The trends can comprise a heatmap indicating a frequency that the one or more additional objects are in different locations of the physical area, routes of the one or more additional objects traversing the physical area, durations in specifical locations in the physical area, or some other trend in association with the movement of the additional objects. In some examples, video processing system 110 uses the video streams from multiple cameras to determine the trends associated with the movement of the additional objects, where each of the video streams and video sources are associated with a different level of distortion identified at least partially from the user input indicating the landmarks for physical area 105.

In at least one implementation, the user provides available movement paths in physical area 105 using the video stream from the corresponding video source of video sources 120-122. In particular, the user can highlight, map, or otherwise indicate the various movement paths for objects in the video stream. Video processing system 110 can use the path information provided by the user to better track the additional objects within the environment. For example, if computing environment is used to monitor the traffic of roads, the user provides input indicating the different paths of the roads in the environment. In an alternative example, for a retail environment, the user will provide information about aisles or other foot traffic areas for people. In some examples, rather than providing the available paths for objects, the map provides the movement paths for the objects and the paths are inferred in the video streams based on the landmarks identified for each of the video streams. For example, the user will indicate the locations of corners or other landmarks in a stream, and the traffic areas are inferred from the landmarks. As additional landmarks are provided by the user, video processing system 110 improves the understanding of the available paths and further improves the understanding of the distortion for each of the video sources.

FIG. 2 illustrates a distortion correction operation 200 to process video surveillance data based on distortion identified in the video streams according to an implementation. The steps of operation 200 are referenced parenthetically in the paragraphs that follow with reference to systems and elements of computing environment 100 of FIG. 1.

Operation 200 includes identifying (201) a video stream from a video source and identifying (202) a map, wherein at least a portion of the physical area represented by the map is monitored by the video source. The map can correspond to a retail location, traffic intersection, commercial business, or some other surveillance location. For example, the map can correspond to an overhead map of a surveillance location. The video stream corresponds to a camera that monitors at least a portion of the physical area represented by the map.

Once the video stream and map are identified, operation 200 further obtains (203) user input identifying objects in the video stream and the map, wherein the user input for each of object of the objects correlates a tag of said object in the video stream to a tag of a representation of said object in the map. In at least one implementation, the user is provided with a visual interface that can display both the video stream and the map. On the map, the user selects a visual representation of the object using a mouse, touchscreen, or some other interface mechanism. Additionally, the user selects the corresponding object in the video stream to define an association. The process is repeated for other objects included within the frame. The objects can include corners of aisles, stoplights, poles, or some other stationary object captured in the video stream.

Once the user input is received, operation 200 determines (204) distortion in the video stream based on the user input. Distortion in a camera refers to the deviation between the actual scene and the way it is captured, often resulting in geometric and spatial inaccuracies in the image. Common types of distortion include barrel distortion, where straight lines appear curved outward, and pincushion distortion, where straight lines curve inward. Although other types of distortion are also possible. Distortion is determined by comparing the user selections of object representations in the map to the objects within the frame itself. For example, video processing system 110 will determine that video source 120 provides fisheye distortion based on the user input, wherein fisheye distortion is a type of optical distortion in photography characterized by a wide-angle perspective that exaggerates the curvature of straight lines, creating a circular or hemispherical effect. A fisheye lens can be used to capture more physical area than other types of lenses but the proportions in different parts of the frame will be different based on the exaggeration caused by the lens. Advantageously, by calculating the distortion caused by the lens, video processing system 110 can more accurately identify the location of other objects (not explicitly defined by the user) in the frame of the video stream. For example, people moving in a retail environment.

After distortion is calculated for the video source and video stream from the user input, operation 200 further monitors (205) movement of one or more additional objects in the video stream and identifies (206) movement trends for the one or more additional objects in the physical area based on the movement, the user input, and the distortion. Referring again to the example of a retail environment represented in physical area 120, video processing system 110 uses the calculated distortion, the user input, and the movement to determine trends associated with the movement of persons within the environment. In monitoring the movement, video processing system 110 uses object recognition software to identify the common traits associated with the desired objects (e.g., human traits). Using the distortion calculated for the video source, video processing system 110 can more accurately determine the location of the additional objects relative the landmarks in the map. The landmarks provided via the user input also provide perspective information relative to the height, orientation, and location of the camera relative to the physical area.

In some implementations, in addition to providing information about landmarks or stationary objects in physical area 105, the user further provides available path information for the additional objects or moving objects. The available path information can be provided via outlines on the map which indicate the different areas that are traversable by the additional objects and the location of the paths in the video streams can be identified from the landmarks and the calculated distortion. In other examples, the paths can be provided by shading, highlighting, or otherwise indicating the various paths in the video stream itself.

In some examples, at least a portion of video sources 120-122 are associated with a distortion estimation provided by the manufacturer of the video source. For example, a manufacturer associated with video source 120 can indicate the type of distortion and the severity of the distortion at different portions within the frame captured by video source 120. The user feedback about landmarks in physical area 105 can be used to supplement the information provided by the manufacturer to provide a more accurate determination of the distortion of the camera. The distortion is then used in conjunction with the user input and the map to determine movement trends associated with the additional objects in the environment.

From the trends, video data 135 is provided to client display 140, wherein the display indicates at least the trends associated with the movement. The trends can include a heatmap overlaid on the map of physical area 105, can comprise a traffic map indicating the path of one or more objects in physical environment 105, can indicate points that one or more objects stopped moving in physical area 105, or can provide some other trend information for the object. Video data 135 can further include at least a portion of video streams 130-132 to be displayed for a user at client display 140.

Additionally, video data 134 from video streams 130-132 can be stored in storage 141. Storage 141 can comprise hard disk drives, solid-state drives, or some other storage media for video data 134 and can be distributed across multiple computing devices and storage locations in some examples. In some implementations, in addition to storing video data, storage 141 stores trend information associated with the movement of objects in the physical area 105. Area definition store 112 provides storage of any associated maps and the user input indicating the association of landmark points in the video stream and the maps.

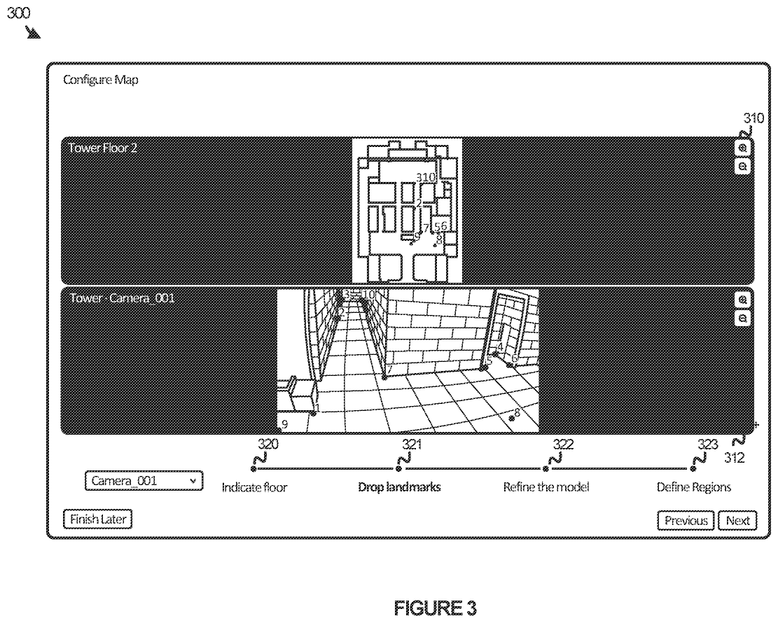

FIG. 3 illustrates a user interface 300 to obtain user input regarding an area of interest according to an implementation. User interface 300 is representative of a user interface that is provided to indicate landmarks or an association of objects in a video stream to representations of the objects in a map. User interface 300 includes map portion 310 and video stream 312. User interface 300 further includes a flow indicator indicating the different steps of relating a video stream of a physical area to a map of the physical area. The steps include operations to indicate floor 320, drop landmarks 321, refine the model 322, and define regions 323.

Here, during the step for drop landmarks 321, a user provides input identifying objects in the video stream and the map, wherein the user input for each of object of the objects correlates a tag of said object in the video stream to a tag of a representation of said object in the map. Specifically, the user will tag an object (e.g., corner in video stream 312) and will define an association to a representation of the object in map 310. The process is repeated as desired by the user (e.g., to provide more accuracy and knowledge of the association, or until a threshold quantity of landmarks are defined).

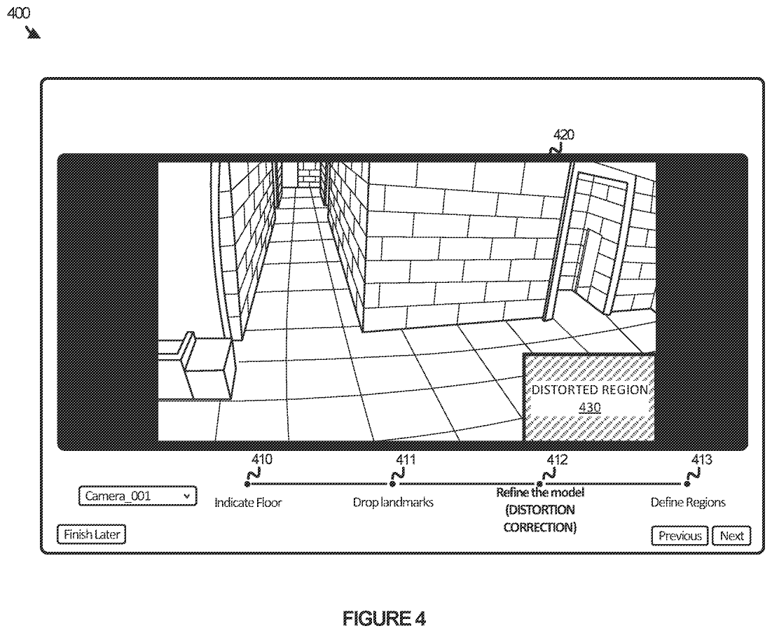

FIG. 4 illustrates a user interface 400 demonstrating calculated distortion from user input according to an implementation. User interface 400 includes video stream 420 with distorted region 430. User interface further includes a flow indicator indicating the different steps of relating a video stream of a physical area to a map of the physical area. The steps include operations to indicate floor 410, drop landmarks 411, refine the model 412, and define regions 413.

Here, based on the user input of the landmarks, which defines a correlation between a tag of an object in the video stream to a tag of a representation of the object in the map, the video processing computing system identifies distorted region 430. Distorted region 430 can represent lens distortion from the video source. Lens distortion includes barrel distortion, where straight lines near the edges of the frame appear curved outward; pincushion distortion, where lines curve inward; and chromatic aberration, causing color fringing due to the lens's inability to focus different colors at the same point. Although other types of lens distortion are possible. For example, the distortion from the video source can comprise barrel distortion at the corner of the video stream. The distortion is used to correct or modify the tracking of movement associated with objects in the specified region. Thus, rather than a flat plane, the identified distortion can be used to determine the physical location of a moving object more accurately, providing better trend analysis associated with the movement of objects.

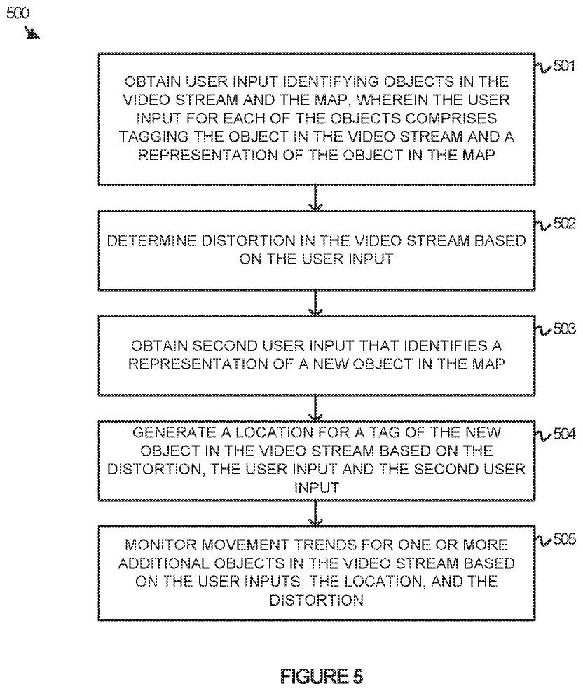

FIG. 5 illustrates an operation 500 to provide suggestions regarding object location based on distortion calculated for a video stream according to an implementation. The steps of operation 500 are referenced parenthetically in the paragraphs that follow with reference to systems and elements of computing environment 100 of FIG. 1.

Operation 500 includes obtaining (501) user input identifying objects in the video stream and the map, wherein the user input for each of the objects comprises tagging the object in the video stream and a representation of the object in the map. As an example, a user associated with a retail environment will identify a corner of an aisle and identify a representation of the corner in the map of the retail environment. The process is repeated for other objects or landmarks that are stationary within the store and represented on the map. After the landmarks in the store are identified, operation 500 further determines (502) distortion in the video stream based on the user input. Distortion refers to the aberration or alteration of an image's shape, typically caused by imperfections in camera lenses resulting in straight lines appearing curved or distorted. For example, lens distortion could make a portion of the image appear closer than reality, such as in the corner of the camera field of view. This can be determined from comparing the tagged objects in the video stream to the tagged representations on the map.

Once the distortion is determined, operation 500 further obtains (503) second user input that identifies a representation of a new object in the map and generates (504) a location for a tag of the new object in the video stream based on the distortion, the user input, and the second user input. For example, because of the distortion, the video processing computing device will suggest a first location for the object in the video stream rather than an expected location, using an ideal lens or video capture device. The user can confirm or modify the suggestion, or the tag can be added without user feedback in some examples. For example, when a user tags a representation of a shelf corner in a retail environment, the computing device can automatically add a tag in the video stream based on learned distortion information. Operation 500 further monitors (505) movement trends for one or more additional objects in the video stream based on the user inputs, the location of the suggested tag, and the distortion. The trends can include paths for the objects, heatmaps indicating frequencies of objects in different locations of the physical area, or some other trend in association with moving objects in the physical area. The moving objects can comprise people, vehicles, robots, or some other moving object in the environment. The objects that are tagged by the user represent stationary objects that can be a reference in relation to the moving additional objects.

Although demonstrated as providing a suggested location for the tag of the object in the video stream, similar operations can be performed when the user tags the object in the video stream. For example, the user can tag the object in the video stream (e.g., corner of a retail shelf). In response to receiving the user input, the computing device can generate a suggested location of the representation of the object in the map based at least on the calculated distortion. From the suggestion, the user can confirm the location, modify the location, or the tag can automatically be added without the user input.

While demonstrated in the previous example as providing the suggested location for the object in the video stream immediately following the tag of the object in the map, the suggestion can be updated as additional objects are tagged in the map and the video stream. For example, a first object will be tagged in the map and the video stream at a first location. As the user provides location information associated with additional objects, the video processing system determines whether the tagged location in the video stream for the first object is accurate relative to the additional objects. Specifically, the additional objects provide information about orientation, location, distortion, and/or artifacts associated with the camera, permitting the video processing system to determine object locations more accurately in the video stream relative to the map.

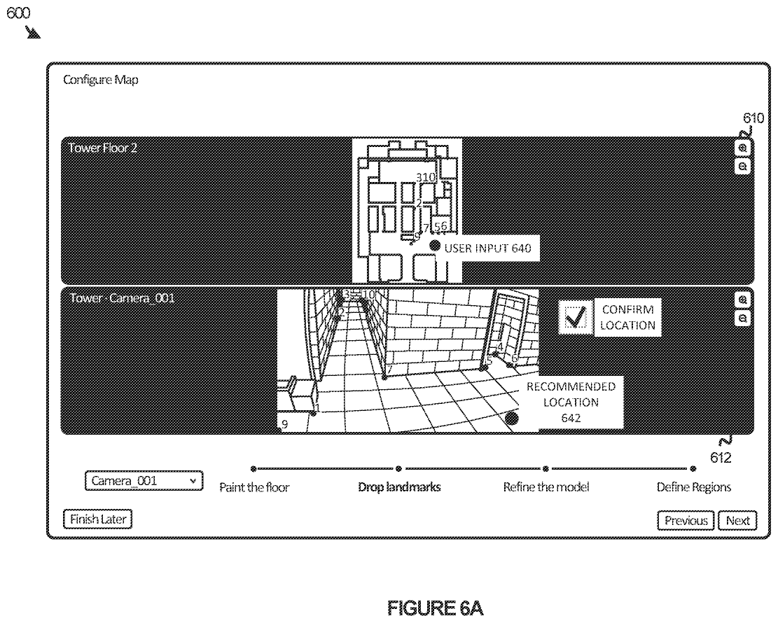

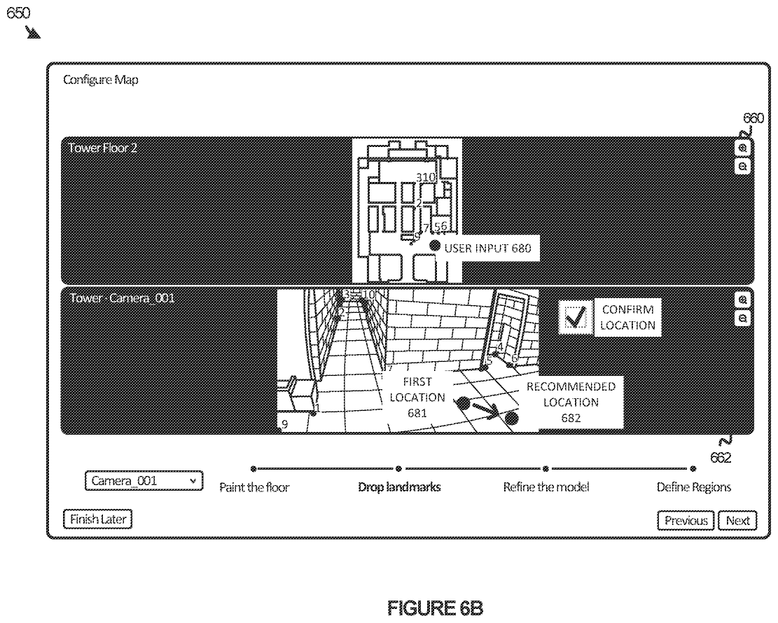

FIG. 6A illustrates a user interface 600 to provide suggestions regarding object location based on distortion calculated for a video stream according to an implementation. User interface 600 includes map 610 and video stream 612. User interface 600 further includes user input 640 in map 610 and recommended location 642 in video stream 612.

In user interface 600, a user provides input indicative of landmarks of a physical area of interest. The physical area can comprise a residential area of interest, commercial area of interest, retail area of interest, or some other area of interest for surveillance. In providing the user input, the user can indicate a correlation between a tag of an object in the stream and a corresponding representation of the object in the video stream. For example, the user can provide input indicating the corner of an aisle and a representation of the aisle in the map of the physical area. From the different landmarks provided by the user, a video processing computing device (e.g., desktop computer, server computer, and the like) will process the image to determine distortion in association with video source. For example, based on the input provided by the user, the computer calculates barrel distortion, which can indicate different distances at the edge of the frame in comparison the center of the frame of the video source. In some examples, the distortion calculation for a video source is supplemented via information provided by the manufacturer, which can indicate the type of distortion and the severity of the distortion. The landmark information provided by the user supplements the information from the manufacturer to provide more precise information about the individual camera.

After landmarks are identified by the user and the distortion is calculated for the video source, the user provides user input 640 indicating a representation of an object in map 610. In response to identifying the user input, the video processing computing device determines a suggested location of the object in the frame of the video stream based on the distortion, previous landmark identification of the user, or some other factor. Here, the video processing computing device provides recommended location 642 in video stream 612. Once the suggestion is provided, the user can confirm the location of the object, can modify the location, or can provide some other input associated with the location of the object in video stream 612. Advantageously, based on previous input for landmarks and the calculated distortion, the computing device can suggest and provide a more accurate estimation of the location of objects in the video stream. Additionally, using the suggested location, the user can determine whether the video processing computing device accurately calculated the distortion associated with the video stream.

FIG. 6B illustrates a user interface 650 to provide suggestions regarding object location based on distortion calculated for a video stream according to an implementation. User interface 650 includes map 660 and video stream 612. User interface 650 further includes user input 680 in map 660, first location 681 in video stream 662, and recommend location 682 in video stream 662.

As described herein, a user will provide information about stationary objects captured in a video stream by tagging the stationary objects in the video stream and a map of the physical area. When more landmarks are added to the model, a video processing system can more accurately determine and define the distortion model associated with the camera providing the video stream. As an example, a user will identify ten stationary objects by tagging the objects in both map 660 and video stream 662. Using the information about the other stationary objects, the video processing system uses feedback to recommend changes to the tagged locations in the video stream. Specifically, based on a determination that the tags for other objects are accurate based on a model for the camera, the video processing system can determine when a tag of an object in video stream 662 is inaccurate.

Using the example in user interface 650, the user provides user input 660 tagging a representation of a stationary object in map 660. Additionally, the user provides first location 661 that tags the corresponding stationary object in video stream 662. In some examples, the video processing system will immediately generate recommended location 682 based on previously tagged stationary objects (i.e., the current model for the camera). The user can then accept or deny the recommended location provided by the video processing system. If the user accepts the position, then the model is maintained. Otherwise, the model is updated based on the user input for the tag.

In another example, the user continues to tag additional stationary objects in map 660 and video stream 662. From the additional objects, the video processing system can retroactively generate recommended location 662 based on the newly identified stationary object locations and the updated model. Advantageously, as the video processing system receives additional information about the stationary objects in the physical environment, the video processing system more accurately identifies distortion and artifacts in the camera. This permits the video processing system to suggest and identify locations of objects in the video stream relative to the map more accurately.

In some implementations, the video processing system maintains a model for the video stream relative to the map, wherein the model is updated based on the stationary objects (i.e., landmarks) defined by the user. The model factors the location, orientation, distortion, or any other factor determined from the user input regarding the stationary objects. When a user tag differentiates from the model by threshold amount, the user interface indicates the deviation and a suggested location for the tag. For example, the tags for nine objects in the map and the video stream may match the model determined by the video processing system. However, the location of a tenth object in the video stream may differ from the model. Accordingly, the video processing system will generate a recommendation based on the model. If the user accepts the recommendation, then the model is maintained. Otherwise, if the user denies the recommendation, the model is updated to reflect the user selection. The update can correspond to distortion, camera location relative to the physical area, orientation, or some other update to the model for the camera.

Although demonstrated as providing a suggestion in video stream 662, the video processing system can also provide suggestions in map 660. Specifically, when user input for a first object in map 660 differs from a predicted location calculated from other user tagged objects (i.e., other stationary object tagged in the physical area), the video processing system can generate a recommended location in map 660. Accordingly, the video processing system can generate a model for objects that relates the map to the visual representation provided in the video stream. As additional objects are defined, the model becomes more accurate and can correlate objects in the video stream to the map, wherein the model identifies the location, orientation, and distortion associated with the camera using the defined objects. When a tag for an object differs from the model by a threshold amount (e.g., by distance), the video processing system will generate a suggested location for the object in either the map or the video stream.

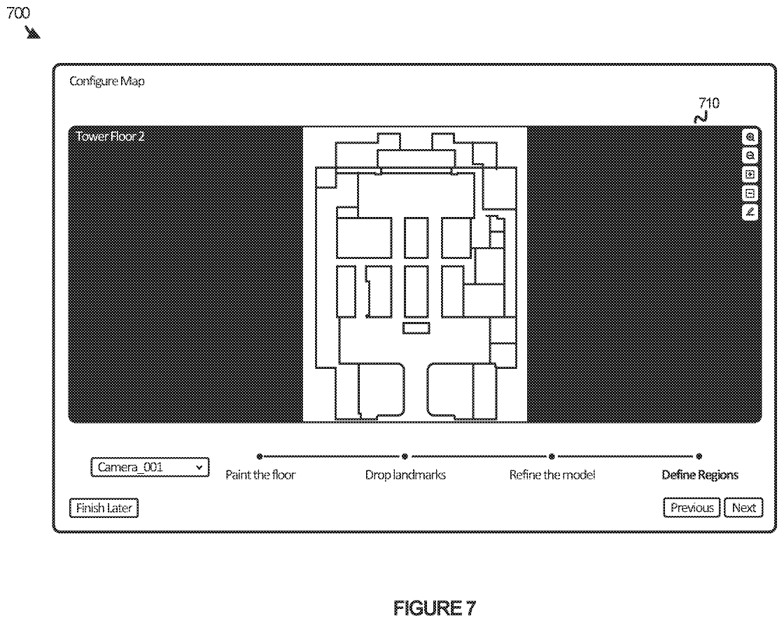

FIG. 7 illustrates a user interface 700 indicating an overhead map according to an implementation. User interface 700 provides overhead map 710 and permits a user to define regions of interest within the map. The regions of interest can be defined using a shader, a highlighter, a lasso or grouping user interface mechanism. The regions are used to support the identification of trends associated with the movement of objects within the physical area. For example, the trends can identify frequently visited regions identified by the user, can identify one or more of the objects that entered a particular region, or can identify some other trend in association with the defined regions by a user. Thus, for a trend display, the video processing computing device can provide a list of objects that entered a defined region of interest.

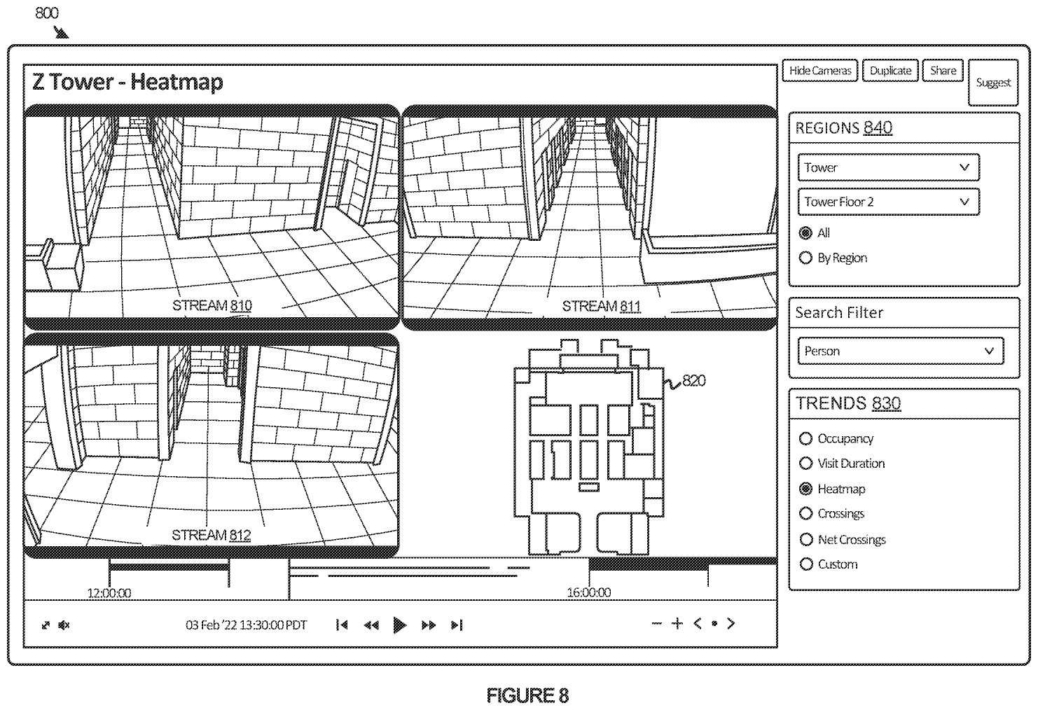

FIG. 8 illustrates a user interface 800 demonstrating a trend identified for a physical area from video streams according to an implementation. User interface 800 includes video streams 810-812, map 820, trends 830, and regions 840. Video streams 810-812 are representative of video streams from surveillance cameras associated with a particular physical area, such as a commercial environment or retail environment. Map 820 is representative of a map of the physical area that includes overhead information for the physical area, such as shelves, aisles, stationary objects, or some other overhead information associated with stationary objects in the physical area. Regions 840 permits a user to select one or more regions defined by the user within the physical area. For example, a first region in a retail environment will represent men's clothing and a second region in the retail environment will represent women's clothing. Trends 830 are representative of different trends associated with the movement of objects (e.g., people, vehicles, robots, etc.) within the environment. The trend information can be displayed wholly or partially on top of map 820. For example, for a heatmap, different colors or shading can be used to demonstrate the frequency that different objects were in different locations in the physical environment represented in the map. In other implementations, the trends are displayed as a list, spreadsheet, or other data structure. For example, a trend can be displayed for occupancy of the physical area (or region of interest) as a function of time. The desired trend from trends 830 and region from regions 840 are selected to determine how the movement data for the objects is displayed to the user.

In some implementations, the user is further presented with a timeline that permits the user to select a range of time relevant for a particular trend. From the timeline and period selected by the user, video streams and trend information are provided for the selected period.

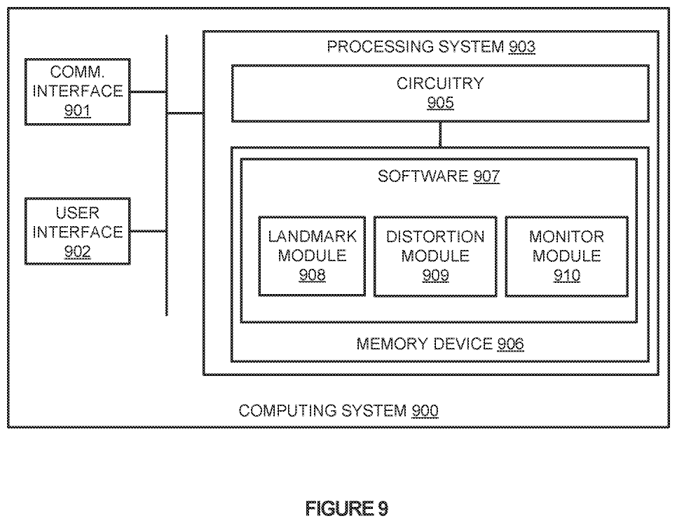

FIG. 9 illustrates a computing system 900 to process video surveillance data based on distortion identified in the video streams according to an implementation. Computing system 900 is representative of any computing system or systems with which the various operational architectures, processes, scenarios, and sequences disclosed herein for a video processing system, such as video processing system 110 of FIG. 1. Computing system 900 comprises communication interface 901, user interface 902, and processing system 903. Processing system 903 is linked to communication interface 901 and user interface 902. Processing system 903 includes processing circuitry 905 and memory device 906 that stores operating software 907. Computing system 900 may include other well-known components such as a battery and enclosure that are not shown for clarity.

Communication interface 901 comprises components that communicate over communication links, such as network cards, ports, radio frequency (RF), processing circuitry and software, or some other communication devices. Communication interface 901 may be configured to communicate over metallic, wireless, or optical links. Communication interface 901 may be configured to use Time Division Multiplex (TDM), Internet Protocol (IP), Ethernet, optical networking, wireless protocols, communication signaling, or some other communication format-including combinations thereof. In some implementations, communication interface 901 may be configured to communicate with one or more video sources including security or surveillance cameras. Communication interface 901 can further be configured to communicate with computing devices that provide storage for the video data associated with the video sources. The computing devices may comprise server computers, desktop computers, or other computing systems available via a local network connection or the internet. Communication interface 901 may also communicate with client computing devices, such as laptop computers or smartphones, permitting a user associated with computing system 900 to provide preferences and selections associated with streams, the overhead map, and the trends of interest.

User interface 902 comprises components that interact with a user to receive user inputs and to present media and/or information. User interface 902 may include a speaker, microphone, buttons, lights, display screen, touch screen, touch pad, scroll wheel, communication port, or some other user input/output apparatus-including combinations thereof. In some implementations, user interface 902 may permit a user to request and process various video data stored in multiple storage locations. User interface 902 may be omitted in some examples.

Processing circuitry 905 comprises microprocessor and other circuitry that retrieves and executes operating software 907 from memory device 906. Memory device 906 may include volatile and nonvolatile, removable and non-removable media implemented in any method or technology for storage of information, such as computer readable instructions, data structures, program modules, or other data. Memory device 906 may be implemented as a single storage device but may also be implemented across multiple storage devices or sub-systems. Memory device 906 may comprise additional elements, such as a controller to read operating software 907. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. In no case is the storage media a propagated signal.

Processing circuitry 905 is typically mounted on a circuit board that may also hold memory device 906 and portions of communication interface 901 and user interface 902. Operating software 907 comprises computer programs, firmware, or some other form of machine-readable program instructions. Operating software 907 includes landmark module 908, distortion module 909, and monitor module 910, although any number of software modules may provide the same operation. Operating software 907 may further include an operating system, utilities, drivers, network interfaces, applications, or some other type of software. When executed by processing circuitry 905, operating software 907 directs processing system 903 to operate computing system 900 as described herein.

In one implementation, landmark module 908 directs processing system 903 to identify a video stream from a video source and identify a map, wherein at least a portion of a physical area represented by the map is monitored by the video source. The video source is a video camera or surveillance camera that captures at least a portion of the physical area. The map represents an overhead view of the physical area that also includes information about objects in the physical area, such as aisles and displays in a retail environment, light poles and sidewalks in an outdoor observation environment, or some other object information. After identifying the map and the video stream, landmark module 908 directs processing system 903 to obtain user input identifying objects in the video stream and the map, wherein the user input for each of object of the objects correlates a tag of said object in the video stream to a tag of a representation of said object in the map. In at least one implementation, computing system 900 displays both the map and the video stream. The user selects objects in the video stream and correlates the objects to representations of the objects in the map. For example, the user will identify a corner of an aisle in a map of the retail environment. The user will then tag the same corner displayed as part of the video stream, such that computing system 900 determines perspective information for the video stream.

From the landmark information (i.e., the tags of the objects in the video stream and the representations of the objects in the map), distortion module 909 directs processing system 903 to determine distortion in the video stream based on the user input. Camera distortion occurs when the optical system fails to accurately represent straight lines or shapes in an image, resulting in aberrations such as barrel or pincushion distortion. These distortions can distort the proportions and perspective of the captured scene, impacting the fidelity of the photograph or video. In some examples, the distortion is a feature, such as a fisheye lens that can capture a wider field of view at the expense of accurately demonstrating straight lines or shapes.

Once the distortion is calculated, monitor module 910 directs processing system 903 to monitor movement of one or more additional objects in the video stream and identify one or more movement trends for the one or more additional objects in the physical area based on the movement, the user input, and the distortion. In some implementations, the objects that are used for landmarks comprise stationary objects, such as lights, aisles, or other objects captured in the frame, while the additional objects represent movable objects, such as people, vehicles, robots, and the like. The additional objects can be identified using object recognition techniques that identify relevant features of an object to determine whether the object is of interest to the desired application (e.g., distinguish between people and other moving objects). From the movement information, monitor module 910 identifies movement trends for the additional objects, wherein the trends comprise heat maps indicating frequencies that different areas are populated by the different objects, regions most frequently visited by the additional objects, paths taken by the different objects, or some other trend in association with the additional objects. In one implementation, monitor module 910 generates a display that indicates at least one of the trends by overlaying the trend in the map of the physical area (e.g., heatmap, path information, and the like). In other implementations, monitor module 910 generates a display of a data structure, such as a list, spreadsheet, or some other data structure that indicates the trend (e.g., quantity of additional objects in the physical area as a function of time). The trends can also be represented using natural language generated from a natural language model that provide information about one or more of the trends.

In some implementations, landmark module 908 further directs processing system 903 to generate suggestions for locations of objects in the video stream or representations of objects in the map. As an example, landmark module 908 directs processing system 903 to obtain user input for a new object in the map, wherein the second user input identifies a representation of the new object in the map. Landmark module 908 then generates a location suggestion for a tag of the new object in the video stream based on the distortion, the previously indicated landmarks, and the newly identified object in the map. From the location suggestion, the user can confirm the location, change the location, or provide some other feedback regarding the suggestion. Similar operations can also be performed when the user tags an object in the video stream and a suggestion is generated in the map. As the quantity of landmarks are defined for the video stream and the map, the calculated distortion is more accurate, permitting the suggested or recommended locations be more accurate.

Although demonstrated in the above example using a single video device or camera, a physical environment can employ multiple cameras to provide the surveillance required. A user can repeat the operations described above for the additional video sources to determine the perspective of each of the cameras for the physical area. The monitored movement from the video sources can be compiled to define the movement trends associated with objects in the physical area.

The included descriptions and figures depict specific implementations to teach those skilled in the art how to make and use the best option. For teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method comprising:
identifying a video stream from a video source;
identifying a map, wherein at least a portion of a physical area represented by the map is monitored by the video source;
obtaining user input identifying objects in the video stream and the map, wherein the user input for each of object of the objects correlates a tag of said object in the video stream to a tag of a representation of said object in the map;
determining distortion in the video stream based on the user input;
monitoring movement of one or more additional objects in the video stream; and
identifying one or more movement trends for the one or more additional objects in the physical area based on the movement, the user input, and the distortion.

2. The method of claim 1, wherein the one or more movement trends comprise a heatmap indicating a frequency that the one or more additional objects are in different locations of the physical area or routes of the one or more additional objects traversing the physical area.

3. The method of claim 1, wherein the distortion updates at least traffic paths in the physical area for movement.

4. The method of claim 1 further comprising:
obtaining second user input for a new object in the map, wherein the second user input identifies a representation of the new object in the map; and
generating a location suggestion for a tag of the new object in the video stream based on the distortion, the user input, and the second user input.

5. The method of claim 1 further comprising:
obtaining second user input for a new object in the video stream, wherein the second user comprises a tag of the new object in the video stream; and
generating a location suggestion for a tag of a representation of the new object in the map based on the distortion, the user input, and the second user input.

6. The method of claim 1 further comprising generating a display of at least one trend of the one or more trends on the map.

7. The method of claim 1, wherein the one or more objects comprise people, vehicles, or robots.

8. The method of claim 1, wherein the map comprises an overhead map of the physical area.

9. The method of claim 1 further comprising:
identifying a second video stream from a second video source; and
wherein identifying one or more movement trends for the one or more additional objects in the physical area is further based on the second video stream.

10. A computing apparatus comprising:
a storage system;
a processing system operatively coupled to the storage system; and
program instructions stored on the storage system that, when executed by the processing system, direct the computing apparatus to:
identify a video stream from a video source;
identify a map, wherein at least a portion of a physical area represented by the map is monitored by the video source;
obtain user input identifying objects in the video stream and the map, wherein the user input for each of object of the objects correlates a tag of said object in the video stream to a tag of a representation of said object in the map;
determine distortion in the video stream based on the user input;
monitor movement of one or more additional objects in the video stream; and
identify one or more movement trends for the one or more additional objects in the physical area based on the movement, the user input, and the distortion.

11. The computing apparatus of claim 10, wherein the one or more movement trends comprise a heatmap indicating a frequency that the one or more additional objects are in different locations of the physical area or routes of the one or more additional objects traversing the physical area.

12. The computing apparatus of claim 10, wherein the distortion updates at least traffic paths in the physical area for movement.

13. The computing apparatus of claim 10, wherein the program instructions further direct the computing apparatus to:
obtain second user input for a new object in the map, wherein the second user input identifies a representation of the new object in the map; and
generate a location suggestion for a tag of the new object in the video stream based on the distortion, the user input, and the second user input.

14. The computing apparatus of claim 10, wherein the program instructions further direct the computing apparatus to:
obtain second user input for a new object in the video stream, wherein the second user comprises a tag of the new object in the video stream; and
generate a location suggestion for a tag of a representation of the new object in the map based on the distortion, the user input, and the second user input.

15. The computing apparatus of claim 10, wherein the program instructions further direct the computing apparatus to generate a display of at least one trend of the one or more trends on the map.

16. The computing apparatus of claim 10, wherein the one or more objects comprise people, vehicles, or robots.

17. The computing apparatus of claim 10, wherein the map comprises an overhead map of the physical area.

18. The computing apparatus of claim 10, wherein the program instructions further direct the computing apparatus to:
identify a second video stream from a second video source; and
wherein identifying one or more movement trends for the one or more additional objects in the physical area is further based on the second video stream.

19. A computing apparatus comprising:
a storage system;
a processing system operatively coupled to the storage system; and
program instructions stored on the storage system that, when executed by the processing system, direct the computing apparatus to:
obtain user input identifying objects in a video stream and a map, wherein the video stream monitors a physical area represented by the map, and wherein the user input for each of object of the objects correlates a tag of said object in the video stream to a tag of a representation of said object in the map;
determine distortion in the video stream based on the user input;
obtain second user input for a new object in the map, wherein the second user input identifies a representation of the new object in the map;
generate a location for a tag of the new object in the video stream based on the distortion, the user input, and the second user input;
monitor movement of one or more additional objects in the video stream; and
identify one or more movement trends for the one or more additional objects in the physical area based on the movement, the user input, the second user input, the location, and the distortion.

20. The computing apparatus of claim 19, wherein the one or more movement trends comprise a heatmap indicating a frequency that the one or more additional objects are in different locations of the physical area or routes of the one or more additional objects traversing the physical area.
